(19) United States
(12) Patent Application Publication
(10) Pub. No.: US 2014/0158818 A1
(43) Pub. Date: Jun. 12, 2014

(54) Looking over-the-horizon system

(71) Applicant: Nathanial Henry Lewis, Fallon, NV (US)

(72) Inventor: Nathanial Henry Lewis, Fallon, NV (US)

(21) Appl. No.: 13/694,502

(22) Filed: Dec. 7, 2012

(51) Int. Cl. B64B 1/24

(52) U.S. Cl. CPC B64B 1/24
USPC 244/30

(57) ABSTRACT

A catamaran airship is tethered to a portable and mobile housing. The roof of the housing will be the landing and take-off place for the airship. Many types of vehicles—truck, ship—can be a mobile base for the housing and its airship. This is primarily a visual surveillance and long-range communication system for day and night, and in all-weather. This system can survey large areas over long periods of time, economically and noiselessly.

### BACKGROUND OF THE INVENTION

1. Field of the Invention

The present invention relates to the field of physical security. Specifically, it relates to the surveillance of a given area and the ability to communicate with other support units. A dual system of surveillance and communication is mounted in a catamaran airship and tethered to a housing below.

2. Description of the Related Art

Any discussion of the prior art throughout the specification should in no way be considered as an admission that such prior art is widely known or forms part of common general knowledge in the field.

Since 1980, the military and border authorities have used large tethered airships at stationary bases; they are used to detect low-flying aircrafts. They are vey bulky and heavy.

The airships of U.S. Pat. Nos. 5,240,206 and 6,843,448 B2, and a surveillance balloon of U.S. Pat. No. 5,115,997 were analyzed. The airships and the balloon are too bulky and heavy for landing on a truck or a ship. In addition, the balloon is not an all-weather vehicle.

### BRIEF SUMMARY OF THE INVENTION

The name of this security system is “LOOKING OVER-THE-HORIZON SYSTEM.” However, it would give advantage to anyone to whom visibility and communication ability are obstructed by tall objects. This is primarily a visual surveillance and long-range communication system for day and night and in all-weather. No new technology is needed.

The system comprises three sub-systems:

1. The airship has a plurality of bodies and is tethered. It is relatively simple and economical to design, manufacture and operate. It is very stable in flight, is all-weather, and has great controllability. This airship is not as bulky and heavy as many other surveillance vehicles.

2. A line of control cables is the medium for the physical, electrical, surveillance and communication connections between the airship and a housing.

3. A base for the housing can be stationary or mobile. Mobile is best. It can be a truck, ship or any other type of vehicle. The housing should be portable; it can then be used by other bases or units. It can be of many designs. A permanent housing can be used as well. The housing roof should be the landing and take-off area for the airship; this saves space. Inside the housing is the control area for the airship, and the data and images collecting and processing areas, for a plurality of surveillance and communication equipments. The housing has its own independent power supply.

### BRIEF DESCRIPTION OF THE DRAWINGS

The drawings will show the advantages and objects of this invention:

FIG. 1 is a side view of a flatbed truck carrying the system;

FIG. 2 is a block diagram showing how parts inside the airship are connected to parts inside the housing, the system;

FIG. 3 is a side view of the airship with many of its features shown;

FIG. 4 is a top view of FIG. 3;

FIG. 5 is a rear view of FIG. 4;

FIG. 6 is a side view of the airship mounted on the roof of the housing;

FIG. 7 is a rear view of FIG. 6, and

is an alternate block diagram showing remote controls.

### DETAILED DESCRIPTION

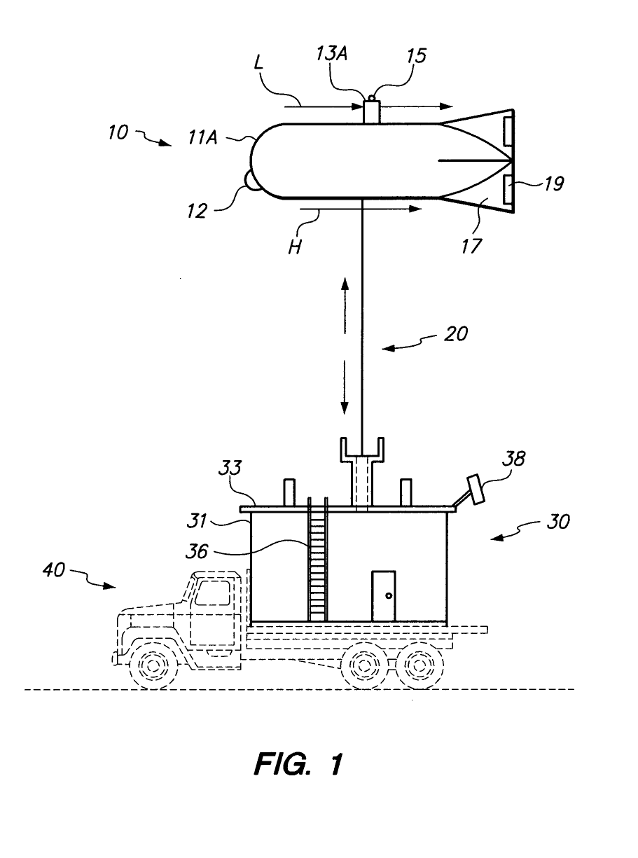

FIG. 1 is an illustration of a rigid tethered catamaran airship 10. Its gas bags within the left body 11A and the right body 11B uses helium gas as its buoyant force or lifting power. One 13A of two fans is shown mounted on top of the left body 11A; it should be lightweight and inside a housing. There is a clearance light 15 for safety mounted on top of the left fan 13A. One 17 of eight fins 17 shown with its rudder 19; there are two upper rudders and two lower rudders. The fins 17 make the airship 10 very stable in flight and the rudders 19 help give the airship 10 great controllability. The outlet 12 is for a high-resolution electro-optic/infrared system in the nose of the left body 11A. The communication system is in the right body 11B. However, they can be reversed.

When both fans 13A and 13B are on at the same time, the lifting power will increase. The fans 13A and 13B airflow will create a low pressure L over the top of the airship 10. These will be a higher pressure H under the airship 10. This pressure difference will cause the airship 10 to rise.

The line 20 is a plurality of control cables; they are the medium between the airship 10 the housing 30. There are four control cables, it is possible to have lesser. The maximum height between the bottom of the airship 10 and the roof of the housing 30 should be 150 feet. This is an optimum height for this type of system.

The housing 30 has an enclosure 31 on all four sides and the floor. A relatively, strong and lightweight roof structure 33 has a dual purpose: it's the roof of the housing 30 and an airport for the airship 10. There is a ladder 36 to the roof and a video camera 38 for observing the airship 10. The housing 30 should be portable; it should be assembled or disassembled in a relatively short time. It can be moved between bases or units; this is the great advantage of portability. The option is still open to a permanent housing. The vehicle 40 that is a mobile base for the housing 30 is a flatbed truck.

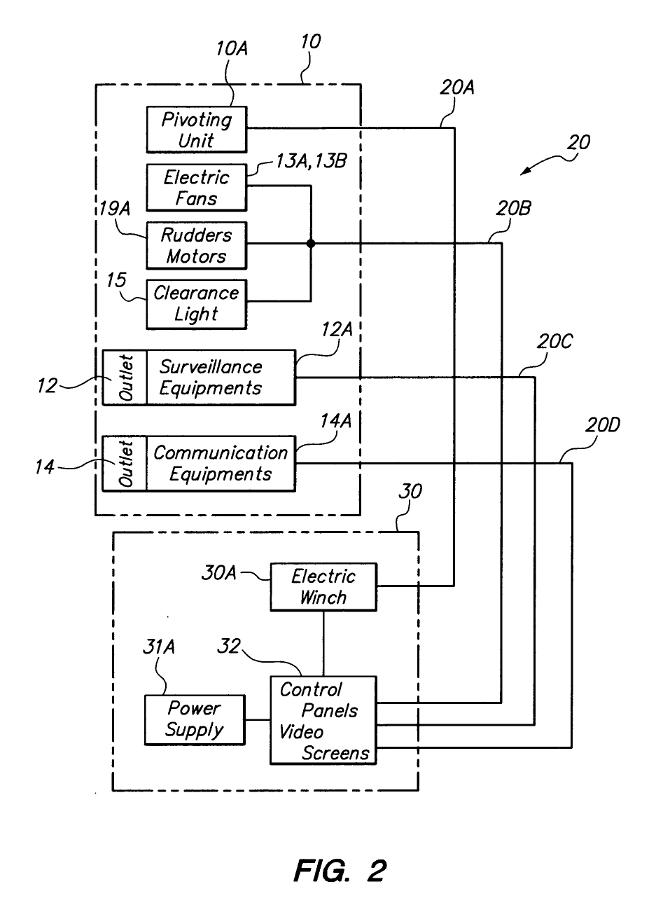

FIG. 2 is a block diagram that shows all the internal connections of the airship 10, a line 20 of control cables, and the housing 30. The control cables consist of a strong lightweight steel cable 20A attached to a pivoting unit 10A that allows the rotational motions of the airship 10. It is tethered by this physical cable 20A and the cable 20A is powered by an electric winch 30A. And there is a lightweight, electrical cable 20B that powers the electric fans 13A. and 13B, rudders' motors 19A, and the clearance light 15. Next, there is a lightweight surveillance cable 20C for its surveillance equipments 12A and a lightweight communication cable 20D for its communication equipments 14A.

The system is integrated and controlled from within the housing 30 by control panels and video screens 32. All surveillance and communication data are displayed or processed. The system should have an independent power supply 31A. However, the power supply 31A should be designed so it can draw its power from the vehicle it is on. A good example would be a ship it is on. Also on a ship the bridge can have a video screen connected to the video system in the housing 30.

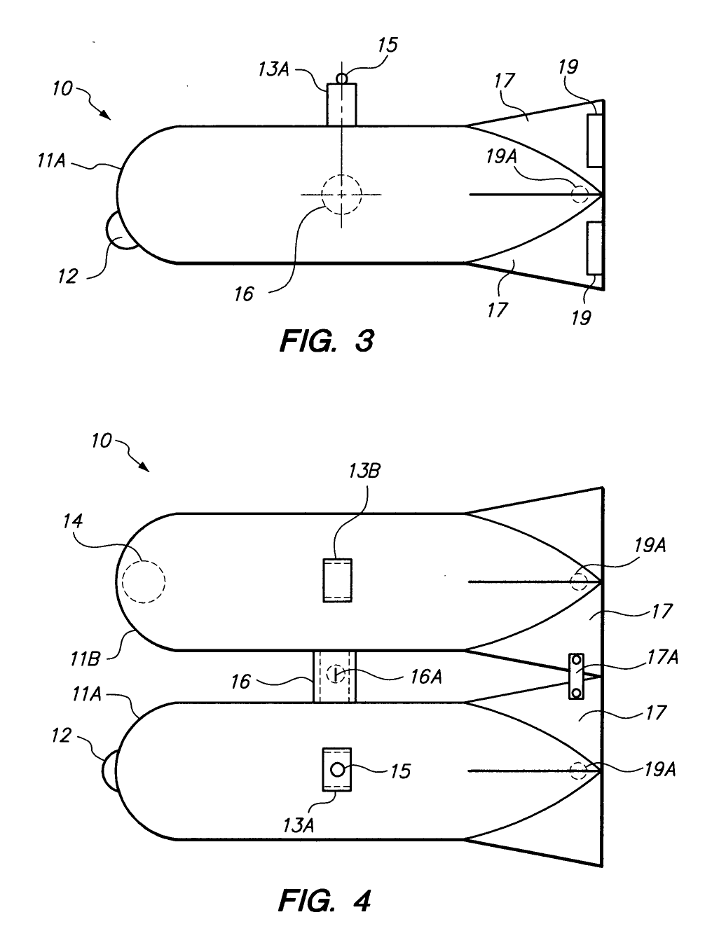

FIG. 3 is a side view of the airship 10 showing its external incorporated parts. The parts are the left body 11A, the surveillance outlet 12, the left fan 13A, the clearance light 15, a tubular connecting structure 16, two of the eight fins 17, and two of the four rudders 19. A motor 19A to power the rudders 19 is incorporated near the vertical fins 17.

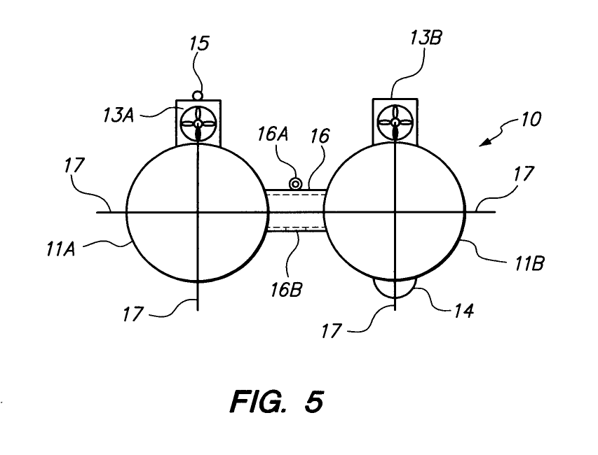

FIG. 4 is a top view of FIG. 3. In addition to the above parts 11A, 12, 13A, 15, 16, 17, 19 and 19A, the new parts are the communication outlet 14, the fins 17 are fastened together by a rectangular plate 17A fastened down, and a lifting ring 16A for moving the airship 10.

The tubular connecting structure 16 joins the left and right twin bodies 11A and 11B of the airship 10 together. The structure 16 is approximately centered between the bodies 11A and 11B, and approximately in alignment with the fans 13A and 13B.

The communication outlet 14 with antennas allows (1) good voice communication with other units; (2) good direction to small, long-range inspection vehicles going to concern areas on land or sea; and (3) observation and controllability over autonomous unmanned underwater or surface vessels, out to a greater range than at present.

FIG. 5 is a rear view of FIG. 4. The new element is a centered hole 16B in the underside of the tubular connecting structure 16, for the control cables 20A, 10B 20C and 20D to pass to the housing 30 below. The hole 16B is substantially aligned with the lifting ring 16A.

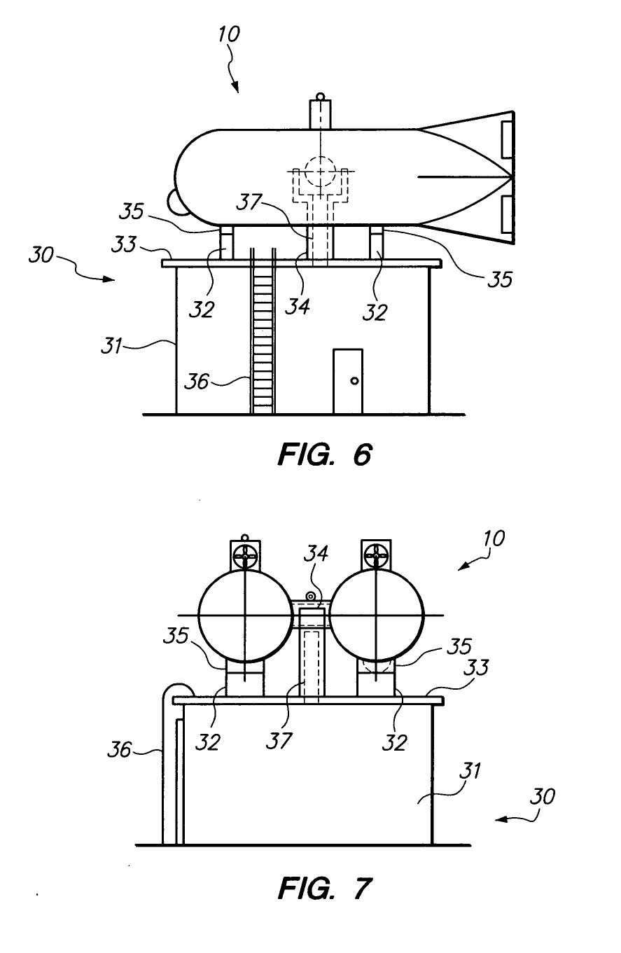

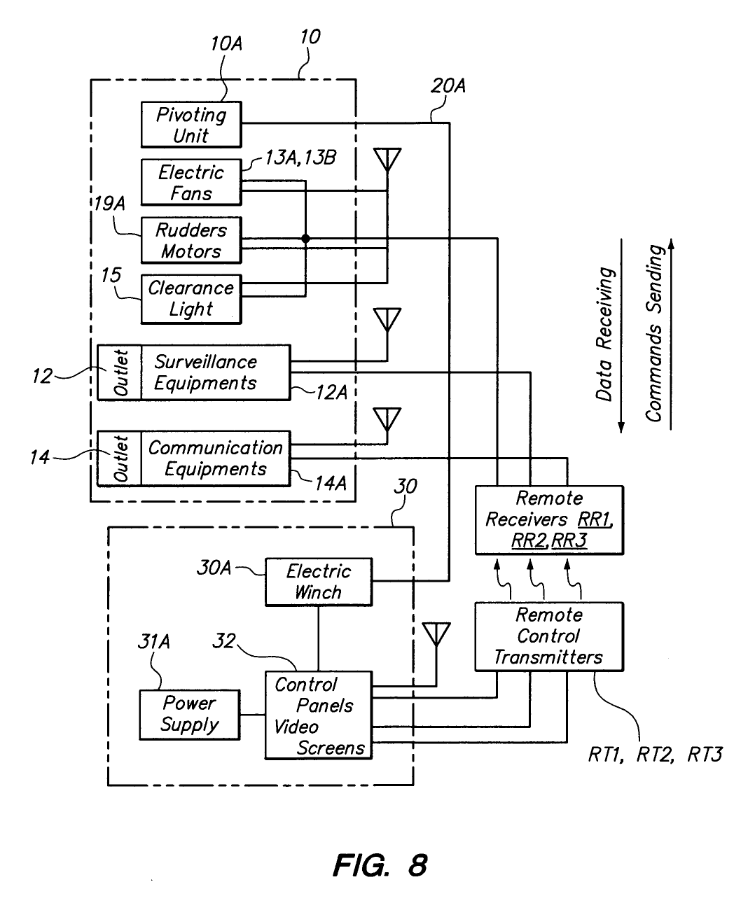

FIGS. 6 and 7 gives good views of the airship 10 and housing 30 combination. The enclosure 31 and ladder 36 are shown; the video camera 38 has been omitted for clarity. The roof structure 33 has four relatively short, outer vertical supports 32 and one taller, y-shape center vertical support 34 mounted to its flat base. In this center vertical support 34 is a vertical hole 37 that can let pass the line 20 of control cables 20A, 20B, 20C and 20D into the interior of the housing 30. The upper ends of all the vertical supports 32 and 34 have paddings 35 for the airship 10 to rest on.

In FIG. 8 three control cables, 20B, 20C, and 20D of FIG. 2, have been replaced with three remote control systems. The remote control transmitters RT1, RT2 and RT3 are mounted on the roof structure 33 of the housing 30 and the remote receivers RR1, RR2 and RR3 are mounted on the underside of the airship 10. This allows commands sending and data receiving by the surveillance and communication equipments through their antennas on both the housing 30 and the airship 10.

A great improvement in batteries and other technologies could offset the weight problem associated with airships. Which is best in bad weather—a cable system or a remote control system? The U.S. Coast Guard large cutters have to go out into storms. The airship 10 should not be made much larger than the following: each body 11A and 11B bring up to 50 feet in length and up to 20 feet in diameter or smaller.

The best type is the rigid airship 10; perhaps a semi-rigid one is, okay but never a non-rigid one. There should be a lightweight lightning rod to give the. airship 10 some protection from lightning strikes.

See FIG. 2. The pivoting unit 10A should allow a 300-degree rotation of the airship 10. The overlapping views of the surveillance camera will give a 360-degree panorama view of a given area. However, the operator should be aware that this is good when then vehicle 40 is stationary. It is not a good idea if the vehicle 40 is moving; see FIG. 1.

See FIG. 4. If any vehicle is moving the airship 10 should be turned 90-degrees only to the left or to the right. The airship 10 will be sideways but this will not create a problem for this catamaran airship 10. A catamaran airship has a side area one-half of the side area of a regular airship of equal lifting ability. Therefore, this catamaran airship 10 will be less affected by cross winds, a great advantage.

If we turn the left fan 13A on and the right fan 13B off and move the rudders 19 to the right (see FIG. 3), the airship 10 will rotate to the right (see FIG. 4). If you reverse the above the airship 10 will rotate to the left. If the rudders 19 and their electric motors 19A are eliminated the airship 10 can still be turned right or left with the fans 13A and 13B, but the turning rate will be, slower.

This system would be great for the Coast. Guard's search and rescue missions due to its height and mobility. It would also be good for the U.S. Navy's

Littoral Combat Ship (LCS). Other applications of this system as described and shown in this invention are: Drones are being used to protect endangered species in national parks; foot patrols have become expensive and dangerous. This system would be good for a complementary ground force. Arctic seagoing traffic is growing fast; the U.S. Coast Guard could use this system on its icebreakers.

It is possible for electronic control technology to be integrated with electronic communication technology. The system now becomes “A VISUAL SURVEILLANCE AND LONG-RANGE COMMUNICATION-CONTROL SYSTEM,” an advanced version. Various surveillance equipments 12A, communication equipments 14A and control equipments can be carried in pods attached under the airship 10.

A much smaller version of this system can be used at the country's many ports and waterways. It would be used in conjunction with other security systems, being used and tested at our ports and waterways. The housing 30 would be much smaller and mounted on an anchored floating platform. The system would be a watchful eye at the entrance of a port or waterway.

For this application of the system a permanent housing 30 would be better than a portable one. It would last longer in areas of extreme bad weather. The power supply 31A inside the housing 30 would use power from solar panels, a wind turbine and batteries.

The airship 10 would be smaller and have a height of 50 feet above the top of the roof structure 33 of the housing 30. It would only be landed for periodic maintenance checks and/or repairs. The rudders 19A and their electric motors 19A are eliminated. The catamaran design and the eight fins 17 would keep the airship 10 very stabile for good day and night and all-weather surveillance, communication and controlling. This port and waterway system would be remote-controlled from a land-based headquarter and electronically monitored by various water vehicles.

Several advantages and objects will be given: This airship 10 is adjustable in height and is noiseless. The airship 10 can be set at, 30 feet for example. This would give you an excellent view of the surrounding area without making the airship 10 too conspicuous.

The airship, 10 can be used in areas from a crowded metropolis to a remote bay due to its portability and independent power supply 31A. It can be camouflaged for good concealment as well. It saves space by landing and taking off from the roof structure 33 of the housing 30.

One other important feature is that the left fan 13A and the right fan 13B together can create a pressure difference about the airship 10; the lifting power of the airship 10 will increase. No new technology is needed but as technology gets better, so will this system.

I claim:

1. A tethered airship comprising a plurality of bodies joined together by a structure:
(a) each said body has an electric powered fan mounted on its top;
(b) said body at its rear has two vertical fins, an upper one and a lower one;
(c) said body at its rear has two horizontal fins, a left one and a right one;
(d) said bodies are fastened together at their rear;
(e) said structure has a hole in its under side, and
(f) a physical, control cable that is attached to pivoting unit in said structure.

2. The airship as claimed in claim 1, further including rigid bodies comprising gas bags therein.

3. The airship as claimed in claim 2, further including one said body comprising an outlet for surveillance, and another said body comprising an outlet for communication.

4. The airship as claimed in claim 1, wherein said connecting structure is approximately centered between bodies.

5. A housing comprising:
(a) an enclosure with four sides and a floor;
(b) a relatively strong and lightweight roof structure;
(c) said roof structure comprising four outer, vertical supports and one center, vertical support mounted on a flat base;
(d) said vertical supports have paddings on their top ends, and
(e) said center, vertical support has a hole through it.

6. The housing as claimed in claim 5, further including an independent power supply.

7. The housing as claimed in claim 6, further including a cable connected to a pivoting unit in said airship, and to winch in said housing.

8. The housing, as claimed in claim 7, further including control panels and video screens that integrate said airship with said housing.
